(19) United States
(12) Patent Application Publication
(10) Pub. No.: US 2014/0257705 A1
(43) Pub. Date: Sep. 11, 2014

(54) CROSSWELL SEISMIC SURVEYING IN A DEVIATED BOREHOLE

(71) Applicant: Stewart Arthur Levin, Menlo Park, CA (US)

(72) Inventor: Stewart Arthur Levin, Menlo Park, CA (US)

(73) Assignee: LANDMARK GRAPHICS CORPORATION, Houston, TX (US)

(21) Appl. No.: 14/240,782

(22) PCT Filed: Sep. 9, 2011
(86) PCT No.: PCT/US11/50985

§ 371 Date: Feb. 25, 2014

(51) Int. Cl. G01V 1/30; E21B 49/00

(52) U.S. Cl. CPC G01V 1/30; E21B 49/00
USPC 702/11

(57) ABSTRACT

First seismic data is collected from a plurality of points on a reflecting feature in the formation by emitting a first seismic signal from a first array of source locations in a deviated portion of a first borehole drilled through a formation and receiving first reflections of the first seismic signal from the reflecting feature by a first array of receiver locations in a deviated portion of a second borehole drilled through the formation. Second seismic data is collected from the plurality of points on the reflecting feature in the formation by emitting a second seismic signal from a second array of source locations in the deviated portion of the first borehole, the second array of source locations being different from the first array of source locations, and receiving second reflections of the second seismic signal from the plurality of points on the reflecting feature by a second array of receiver locations in the deviated portion of the second borehole. The collected first seismic data and the collected second seismic data are analyzed to draw conclusions about the formation. The conclusions about the formation are used to take an action concerning the formation.

### BACKGROUND

In crosswell (or cross-well or cross hole) seismic surveying, receivers are placed in a first borehole and a seismic survey is performed with one or more sources placed in a second borehole, either directly or numerically constructed. Such surveying techniques are sometimes used to gather seismic data about the formations in the vicinity of the two boreholes. That information is sometimes used to improve the production of hydrocarbons from those formations. For example, in the simple case of a horizontally-stratified subsurface, a crosswell survey between two vertical boreholes records multi-fold seismic reflections from within a thin two-dimensional subsurface sheet passing through the boreholes while a crosswell survey between a vertical and a horizontal borehole records single-fold reflections from triangular wedges on each reflector. Gathering seismic data, and in particular multi-fold seismic data, that illuminates more than a thin two-dimensional sheet passing through the boreholes using crosswell seismic surveying techniques is a challenge currently addressed using a multiplicity of additional boreholes with concomitant expense.

### BRIEF DESCRIPTION OF THE DRAWINGS

FIG. 1 illustrates a configuration of two boreholes.

FIG. 2 illustrates the sum of the projections of direction vectors of the boreholes illustrated in FIG. 1 onto a planar reflector.

FIG. 3 illustrates a rotation of the borehole configuration shown in FIG. 1.

FIG. 4 illustrates a double helix configuration of boreholes.

FIG. 5 illustrates a single helix borehole.

FIG. 6 illustrates a spiral helix borehole.

FIG. 7 illustrates the conditions under which the data shown in FIG. 8 is collected.

FIG. 8 illustrates the pattern of the location of data collected using a helical borehole.

FIG. 9 illustrates seismic sources and seismic receivers in a borehole.

FIG. 10 is a flow chart.

FIG. 11 illustrates collecting seismic data from below a reflector and from above a reflector.

FIG. 12 illustrates passive collection of seismic data.

FIG. 13 is an illustration of an environment including a remote real time operating center.

### DETAILED DESCRIPTION

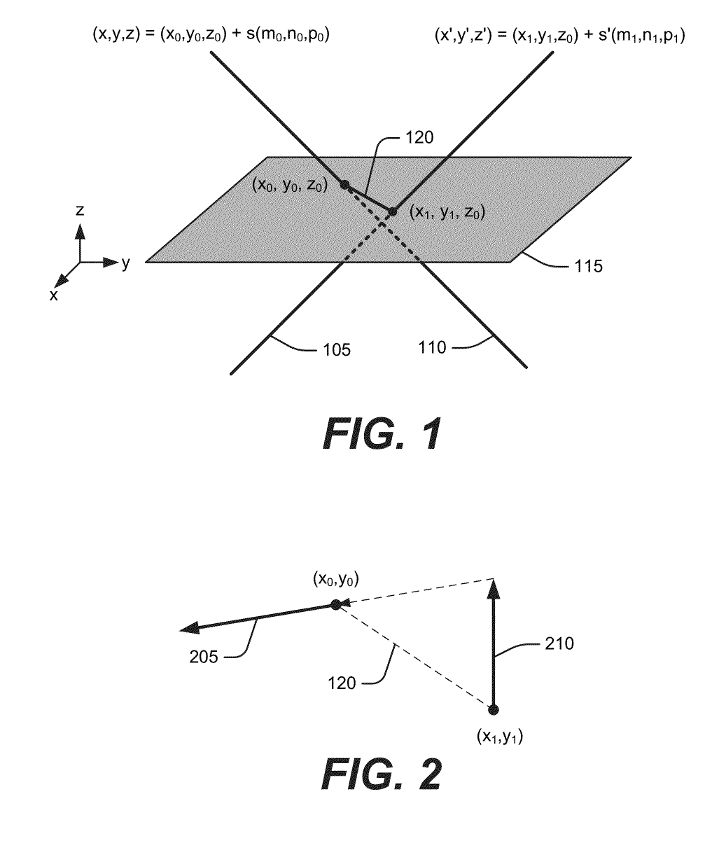

Consider the borehole configuration illustrated in FIG. 1, in which two boreholes 105 and 110 are drilled through a planar reflector (e.g., a boundary between two dissimilar lithologies such as sand and shale) 115 at points (x₀,y₀,z₀) and (x₁,y₁,z₀), respectively. Crosswell techniques increase multi-fold seismic data gathering capabilities using (a) boreholes crossed in a “symmetric X pattern,” (b) two boreholes arranged as a double helix, (c) a single spiral borehole, and (d) generally, a single deviated borehole.

Acoustic energy is emitted from points along one of the boreholes and received at points along the other borehole. In one embodiment, the boreholes can be arranged in a geometry relative to each other and the reflector such that points along a line between the points where the two boreholes penetrate the reflector receive multi-fold seismic coverage.

To illustrate, assume constant velocity (straight ray) formations and straight line boreholes with a horizontal reflector at z=z₀, as shown in FIG. 1. A parametric description of the boreholes may be written as:

(x, y, z)=(x₀, y₀, z₀)+s(m₀, n₀, p₀) (1)

(x′, y′, z′)=(x₁, y₁, z₀)+s′(m₁, n₁, p₁) (2)

where:

the intersections of the boreholes with the horizontal reflector are at (x₀,y₀,z₀) and (x₁,y₁,z₀) respectively,

the m,n,p are corresponding direction vectors leading away from those intersection points, and

s and s′ are scalar parameters determining position along the line.

Since the reflector 115 is horizontal, a reflected ray has a transmitted mirror image to a mirrored borehole with reversed sign on p. So the ray connecting (x,y,z) to a mirrored borehole point (x′,y′,z′) is given by:

(\hat{x},ŷ,\hat{z})=(x₀, y₀,z₀)+s(m₀, n₀, p₀)+r[(x₀, y₀,z₀)+s(m₀, n₀, p₀)−(x₁, y₁,z₀)+s′(m₁,n₁, −p₁)] (3)

for another scalar parameter r. To find where this line intersects the horizontal plane, a solution is found for the pair of equations:

z0 =(1+r)(z₀+sp₀)−r(z₀−s′p₁) (4)

0=(1+r)sp₀+rs′p₁ (⁵)

for the parameter r, yielding:

$$\begin{matrix}r = \frac{- {sp}_{0}}{{sp}_{0} + {s}^{′} {p}_{1}} , and & ( 6 ) \\ 1 + r = \frac{{s}^{′} {p}_{1}}{{sp}_{0} + {s}^{′} {p}_{1}} & ( 7 )\end{matrix}$$

and the intersection point on the plane being at:

\hat{x}=(1+r)(x₀+sm₀)−r(x₁+s′m₁) (8)

ŷ=(1+r)(y₀+sn₀)−r(y₁+s′n₁) (9)

Substituting r from equation (6) into equations (8) and (9) and rearranging terms results in:

(sp₀+s′p₁)\hat{x}=sp₁(x₀+sm₀)+sp₀(x₁+s′m₁) (10)

(sp₀+s′p₁)ŷ=sp₁(y₀+sn₀)+sp₀(y₁+s′n₁) (11)

Dividing by s′s and rearranging results in:

$$\begin{matrix}0 = ( {p}_{1} {m}_{0} + {p}_{0} {m}_{1} ) + \frac{1}{s} {p}_{1} ( {x}_{0} - \hat{x} ) + \frac{1}{{s}^{′}} {p}_{0} ( {x}_{1} - \hat{x} ) & ( 12 ) \\ 0 = ( {p}_{1} {n}_{0} + {p}_{0} {n}_{1} ) + \frac{1}{s} {p}_{1} ( {y}_{0} - \hat{y} ) + \frac{1}{{s}^{′}} {p}_{0} ( {y}_{1} - \hat{y} ) & ( 13 )\end{matrix}$$

which is a pair of linear equations in the two unknowns 1/s and 1/s′. For any given fixed intersection point in the horizontal reflecting plane, this system of equations will generally have a unique solution unless the determinant of the 2×2 matrix:

$$\vert \begin{matrix}\begin{matrix}{p}_{1} ( {x}_{0} - \hat{x} ) & {p}_{0} ( {x}_{1} - \hat{x} ) \\ {p}_{1} ( {y}_{0} - \hat{y} ) & {p}_{0} ( {y}_{1} - \hat{y} )\end{matrix} \vert & ( 14 )\end{matrix}$$

is zero. In that case, there are either infinitely many solutions, i.e., multi-fold and/or multi-azimuth coverage or no illumination at all. Equating the determinant to zero yields:

0=p₁p₀[(x₀−\hat{x})(y₁−ŷ)−(x₁\hat{x})(y₀−ŷ)] (15)

which, leaving out the case of a horizontal well in the reflection plane (i.e., where p₀=0 or where p₁=0), gives the relation:

$$\frac{{y}_{0} - \hat{y}}{{x}_{0} - \hat{x}} = \frac{{y}_{1} - \hat{y}}{{x}_{1} - \hat{x}} \qquad ( 16 )$$

meaning that the point (\hat{x},ŷ,\hat{z}₀) lies on the line connecting (x₀,y₀,z₀) to (x₁,y₁,z₀). To determine whether there are rays reflecting off this line, the slope of the line is denoted by q and is substituted into equations (12) and (13) to produce:

$$\begin{matrix}0 = ( {p}_{1} {m}_{0} + {p}_{0} {m}_{1} ) + \frac{1}{s} {p}_{1} ( {x}_{0} - \hat{x} ) + \frac{1}{{s}^{′}} {p}_{0} ( {x}_{1} - \hat{x} ) & ( 17 ) \\ 0 = \frac{( {p}_{1} {n}_{0} + {p}_{0} {n}_{1} )}{q} + \frac{1}{s} {p}_{1} ( {x}_{0} - \hat{x} ) + \frac{1}{{s}^{′}} {p}_{0} ( {x}_{1} - \hat{x} ) & ( 18 )\end{matrix}$$

whence the requirement:

$$q = \frac{( {p}_{1} {n}_{0} + {p}_{0} {n}_{1} )}{( {p}_{1} {m}_{0} + {p}_{0} {m}_{1} )} \qquad ( 19 )$$

In a geometric interpretation, p₀ and p₁ may be normalized to 1 in which case, the relation reduces to:

$$q = \frac{( {n}_{0} + {n}_{1} )}{( {m}_{0} + {m}_{1} )} \qquad ( 20 )$$

This indicates, as shown in FIG. 2, that the vector sum of the projections 205 and 210 of the direction vectors (m₀,n₀,p₀) and (m₁,n₁,p₁), respectively, onto the planar reflector 115 overlay the line 120 connecting (x₀,y₀,zₒ) to (x₁,y₁,z₀). This relationship between the two boreholes 105 and 110 is defined to be a “symmetric X pattern.” A more general “symmetric pattern” includes “wavy” boreholes that are not straight lines but are mirror images of each other on opposite sides of a plane passing through the normal to a reflector. For example, if wavy borehole 1 includes segments S₁₁ and S₁₂ and wavy borehole 2 includes segments S₂₁ and S₂₂, segments S₁₁ and S₂₁ might form a symmetric X pattern and segments S₁₂ and S₂₂ might form a symmetric X pattern. Take the example in which q=0; then n₀=−n₁, meaning that the y components point in equal and opposite directions.

This embodiment provides trapezoidal areal coverage of the reflector with multi-fold coverage of a linear subset (that connecting opposite corners of the trapezoid that terminate at each borehole) without the need for additional boreholes. In at least some settings, this may be sufficient for analysis of the formation in the vicinity of the boreholes and a target zone for hydrocarbon exploration and production.

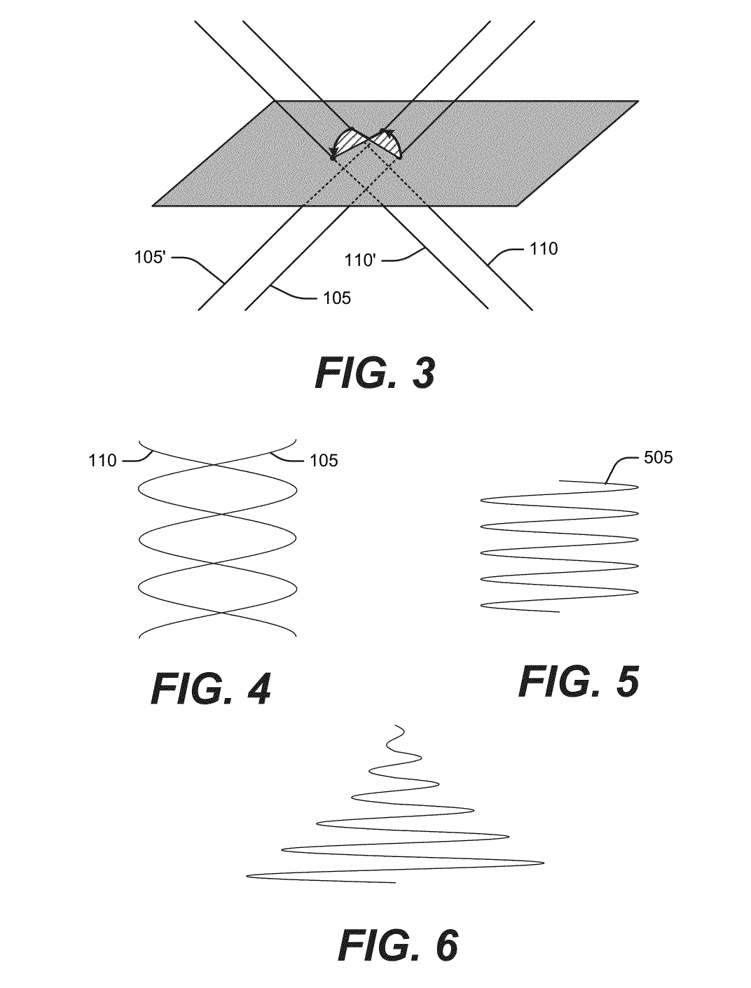

If one were to rotate the two boreholes with respect to the planar reflector 115, e.g., from 105 to 105′ and from 110 to 110′ as shown in FIG. 3, while maintaining their “symmetric X pattern” relationship, an area on the planar reflector 115, indicated by the cross-hatching in FIG. 3, would have multi-fold coverage. In one embodiment the two boreholes are configured in the double helix configuration shown in FIG. 4. In one embodiment, one or more seismic sources, such as acoustic transmitters, are fixed or are moved up and down within one of the boreholes, say borehole 105, and an array of seismic sensors, such as acoustic receivers, are fixed or are moved up and down within the other borehole, say borehole 110. In one embodiment, this configuration results in the line of multi-fold coverage shown in FIG. 1 advancing along the path of the double helix.

In one embodiment, the two helices shown in FIG. 4 are merged into a single helical borehole 505, as shown in FIG. 5. In one embodiment, seismic receivers are fixed within the helical borehole and a seismic source (or sources) is moved within the borehole 505. In one embodiment, the seismic receivers move within the borehole 505 and the seismic source (or sources) are fixed. In one embodiment, both seismic sources and receivers are moved within their respective boreholes. In one embodiment both receivers and sources are fixed within their respective boreholes, with the sources being individually activated rather than moved as in the previous embodiment. In one embodiment, either the sources or the receivers are on the surface and are numerically constructed in a virtual borehole to achieve the desired pattern.

In one embodiment, a borehole having the shape of a “spiral helix,” such as that shown in FIG. 6, is used. In one embodiment, a deviated borehole of arbitrary three-dimensional shape (i.e., not a two-dimensional shape such as an arc lying in a single plane) is used. In one embodiment, virtually any borehole that curves around in a manner similar to that shown in FIGS. 4-6 can be used. In these cases in which seismic transmitters and receivers are arrayed along a deviated borehole, dense multi-fold, multi-azimuth coverage is achieved.

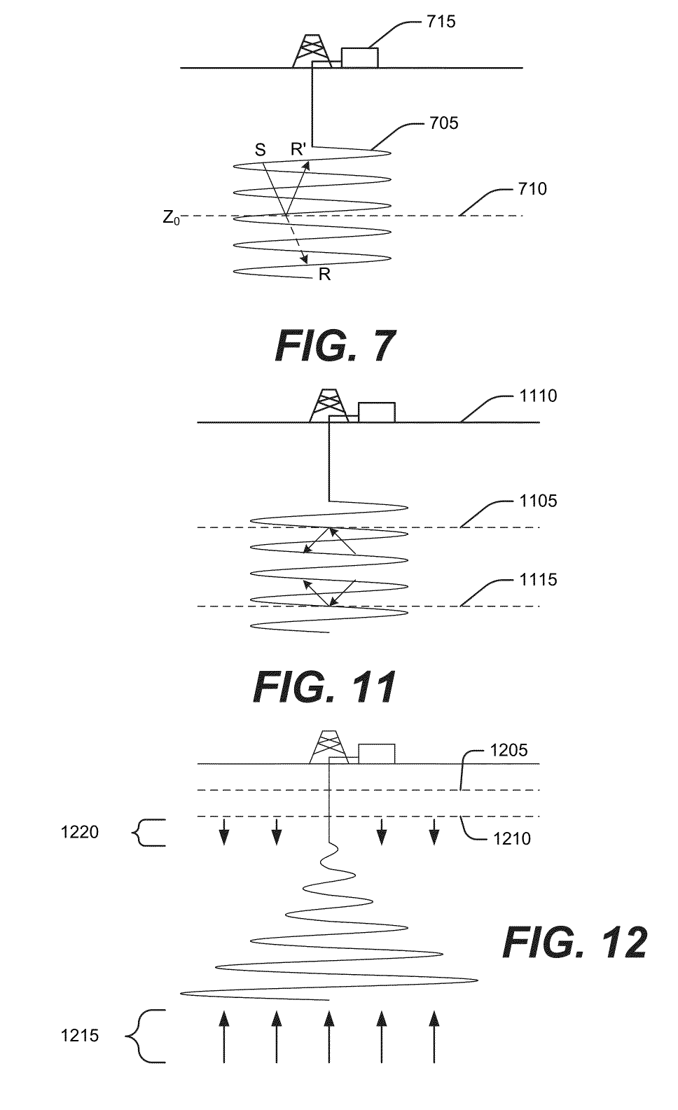

To illustrate the type of coverage that can be achieved, consider the helical borehole 705 of radius r shown in FIG. 7. For a fixed source location S on helix 705 and any given receiver R′ on the helix, the ray that reflects off a reflector 710 at level Z₀ and arrives at the receiver R′ can be determined by connecting a straight line from the source to the mirror image R of the receiver about the plane at Z₀.

The parametric equation of a line connecting two points (X_{S}, Y_{S}, Y_{S}) and (X_{R}, Y_{R}, Z_{R}) is given by:

$$\frac{X - {X}_{S}}{{X}_{R} - {X}_{S}} = \frac{Y - {Y}_{S}}{{Y}_{R} - {Y}_{S}} = \frac{Z - {Z}_{S}}{Z - {Z}_{S}} \qquad ( 21 )$$

Take, without loss of generality, the center of the helix at its starting point as the origin X=Y=Z=0 and the intersection of the helix with the plane at Z₀ to have Y=0. Then the equation of the mirror helix may be written as:

X_{R}=rcos θ

Y_{R}=rsin θ

Z_{R}=Z₀+arθ (22)

with its unmirrored coordinates using −θ instead of θ. Plugging equation (22) into equation (21) and setting Z=Z₀ gives the parametric representation:

$$\begin{matrix}{X}_{0} = r cos \frac{{Z}_{0} - {Z}_{S}}{ar} + r ( cos \frac{{Z}_{R} - {Z}_{0}}{ar} - cos \frac{{Z}_{0} - {Z}_{S}}{ar} ) \frac{{Z}_{0} - {Z}_{S}}{{Z}_{R} - {Z}_{S}} & ( 23 ) \\ {Y}_{0} = - r sin \frac{{Z}_{0} - {Z}_{S}}{ar} + r ( sin \frac{{Z}_{R} - {Z}_{0}}{ar} + sin \frac{{Z}_{0} - {Z}_{S}}{ar} ) \frac{{Z}_{0} - {Z}_{S}}{{Z}_{R} - {Z}_{S}} & \end{matrix}$$

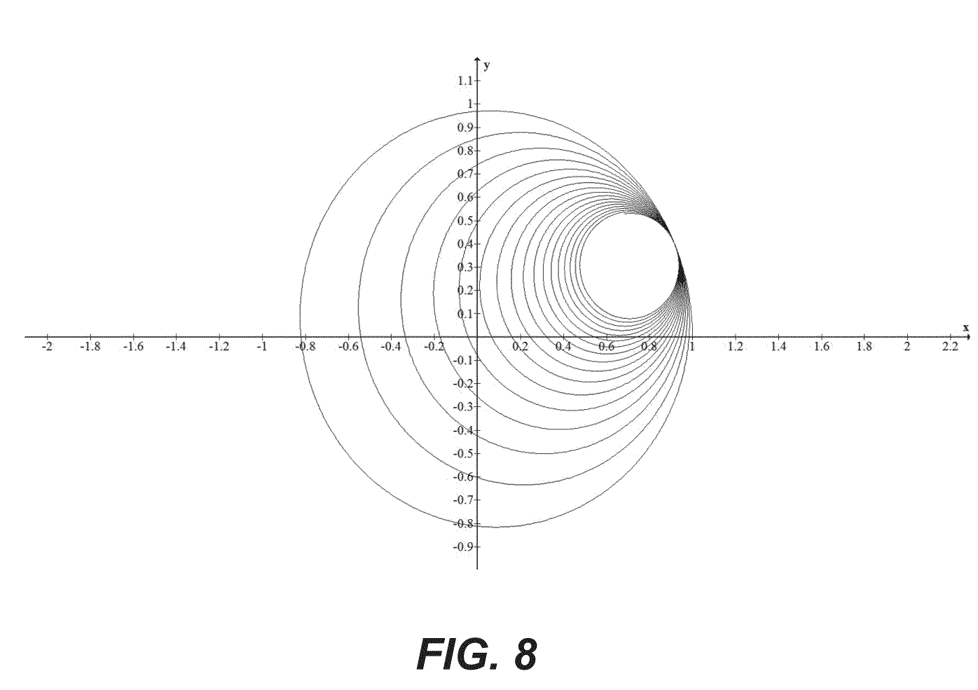

for the location of the reflection point on the plane. Numerically evaluating equation (23) with r=1, Z₀=10, a=0.645, and Z_{R} ranging from 30 to 100 yields an inward spiraling trajectory tangent to the circumference of the helix at a point directly below the source, as shown in FIG. 8.

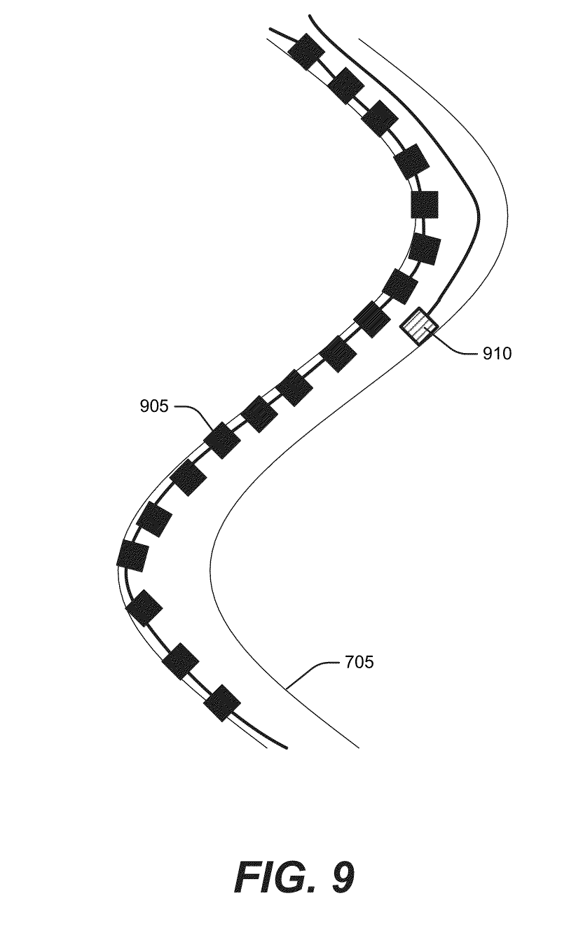

In one embodiment, illustrated in FIG. 9, a string of seismic receivers 905 (only one is labeled) is positioned in the borehole 705. It will be understood that the number of seismic receivers shown in FIG. 9 is arbitrary and can be much greater or much smaller than shown. In one embodiment, the seismic receivers are magnetic geophones. In one embodiment, the seismic receivers are fiber optic acoustic receivers. In one embodiment, the acoustic receivers use another similar technology.

In one embodiment, as shown in FIG. 9, a seismic source 910 is positioned in the borehole 705. In one embodiment, the seismic source is a controlled source such as a sparker or a vibrator. In one embodiment, the seismic source is an uncontrolled, but directly measured source, such as a drill bit. It will be understood that the number of seismic sources 910 shown in FIG. 9 is arbitrary and can be larger than is shown. Further, in one embodiment the number of seismic sources is larger than the number of seismic receivers. For example, in one embodiment, the designator 905 in FIG. 9 refers to the seismic sources and the designator 910 refers to the seismic receiver.

In one embodiment, the string of seismic receivers 905 and the seismic source 910 are coupled to a computer system 715 that is either on the surface as shown in FIG. 7 or is installed in the borehole 705. In one embodiment, the computer system includes all of the equipment necessary to interface with the seismic receivers 905 and the seismic source 910 and in particular to perform the computations described above in order to provide multi-fold, multi-azimuth seismic coverage over an extent of the formation being investigated.

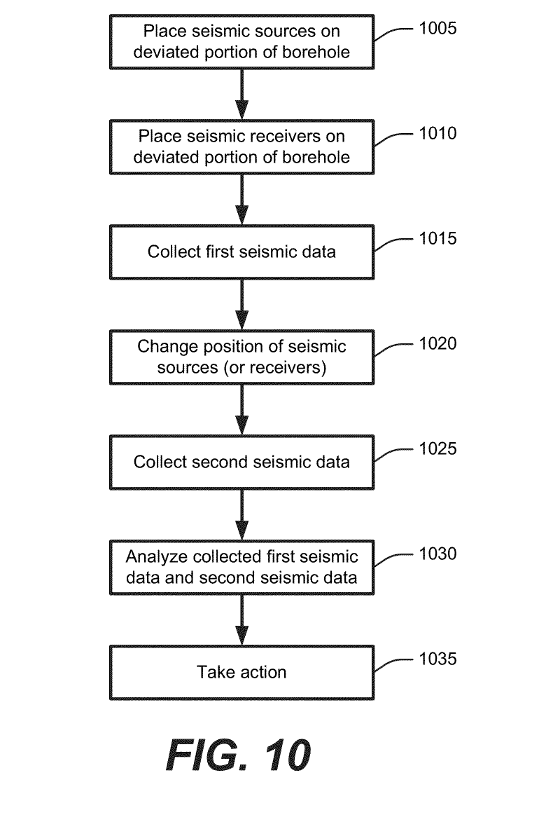

In one embodiment of use, as shown in FIG. 10, the seismic sources are placed along a deviated portion of the borehole 705 (block 1005). In one embodiment, the seismic receivers are also placed along a deviated portion of the borehole 705 (block 1010). In one embodiment, a first set of seismic data is then collected from a reflecting feature, such as a boundary between two sedimentary layers, by emitting a seismic signal from the seismic sources and receiving reflections of the seismic signal from the reflecting feature by the seismic receivers (block 1015). In one embodiment, the seismic sources (or the seismic receivers) are then repositioned along the deviated portion of the borehole 705 (block 1020). In one embodiment, a second set of seismic data is then collected from the reflecting feature by emitting a seismic signal from the seismic sources and receiving reflections of the seismic signal from the reflecting feature by the seismic receivers (block 1025). In one embodiment, the first set of seismic data and the second set of seismic data are then analyzed, for example as described above, to draw conclusions about the formation (block 1030), such as the location of the reflector 710 in FIG. 7 or the locations and characteristics of other features in the formation being investigated. In one embodiment, an action is then taken based on the conclusions (block 1035). For example, in one embodiment, the conclusions are used to decide whether to drill a well, where to drill a well, whether to continue production from a formation, and/or a variety of other similar decisions.

In one embodiment, as shown in FIG. 11, the reflector 1105 being investigated is closer to the surface of the earth 1110 than the seismic source or the seismic receiver, as indicated by the top set of arrows in FIG. 11. In one embodiment, as shown in FIG. 11, the reflector 1110 being investigated is at a greater distance from the surface of the earth 1110 than the seismic source or the seismic receiver, as indicated by the bottom set of arrows in FIG. 11.

In one embodiment, as shown in FIG. 12, the technique is used to investigate a zone of interest, bounded in FIG. 12 by boundaries 1205 and 1210. For example, in an environmental application, such as sequestering carbon dioxide from an industrial source such as a power plant, the expense of repeated active source surveys can make the economics of such projects infeasible. The field of seismic interferometry, adapted from the earthquake community, provides ways to use passive recording of ambient noise in the earth, remote earthquake arrivals being prototypical, to estimate what an active source survey would record. Some ocean bottom marine recordings have shown promising results, although the randomness of the ambient noise severely limits how well repeated passive surveys can be compared. Interferometry on land is more difficult because much of the seismic energy recorded at the surface arises from cultural and environmental sources such as traffic and wind which reach the instrumentation via surface waves that never probe the subsurface reservoir (1205-1210) desired to be imaged and monitored. By spiraling the recording cable below the reservoir, as shown in FIG. 12, the surface noise is avoided and the upcoming body waves 1215 and reflections 1220 are more readily captured.

The economics of such a configuration for long-term monitoring of carbon dioxide is appealing because of recent technological advances in fiber optic-based recording instruments and cables that may be deployed in the borehole. Such cables require no downhole power source and are probed purely with surface-based lasers. This allows the cable to be left in place permanently and probed and recorded on request. This allows the higher front-end cost of drilling a helical borehole, or the like, to be amortized across many rears of low cost repeat passive surveys.

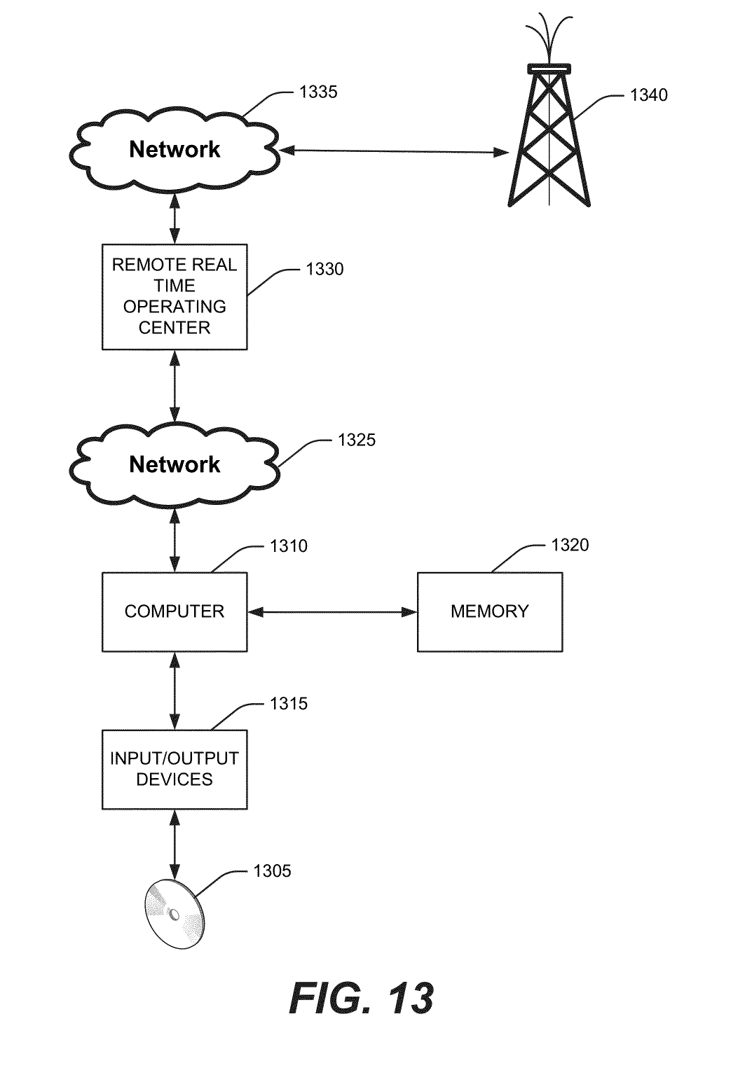

In one embodiment, a computer program for controlling the operation of one of the systems shown in FIG. 7 is stored on a computer readable media 1305, such as a CD or DVD, as shown in FIG. 13. In one embodiment a computer 1310, which may be the computer 715, or a computer located below the earth's surface, reads the computer program from the computer readable media 1305 through an input/output device 1315 and stores it in a memory 1320 where it is prepared for execution through compiling and linking, if necessary, and then executed. In one embodiment, the system accepts inputs through an input/output device 1315, such as a keyboard, and provides outputs through an input/output device 1315, such as a monitor or printer. In one embodiment, the system stores the results of calculations in memory 1320 or modifies such calculations that already exist in memory 1320.

In one embodiment, the results of calculations that reside in memory 1320 are made available through a network 1325 to a remote real time operating center 1330. In one embodiment, the remote real time operating center 1330 makes the results of calculations available through a network 1335 to help in the planning of oil wells 1340, in the drilling of oil wells 1340, or in production of oil from oil wells 1340. Similarly, in one embodiment, the systems shown in FIGS. 7, 11, and 12 can be controlled from the remote real time operating center 1330.

The text above describes one or more specific embodiments of a broader invention. The invention also is carried out in a variety of alternate embodiments and thus is not limited to those described here. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-based method comprising:
a computer collecting first seismic data from a plurality of points on a reflecting feature in the formation by emitting a first seismic signal from a first array of source locations in a deviated portion of a first borehole drilled within a formation and receiving first reflections of the first seismic signal from the reflecting feature by a first array of receiver locations in a deviated portion of a second borehole drilled within the formation;
the computer collecting second seismic data from the plurality of points on the reflecting feature in the formation by emitting a second seismic signal from a second array of source locations in the deviated portion of the first borehole, the second array of source locations being different from the first array of source locations, and receiving second reflections of the second seismic signal from the plurality of points on the reflecting feature by a second array of receiver locations in the deviated portion of the second borehole;
the computer analyzing the collected first seismic data and the collected second seismic data to draw conclusions about the formation;
using the conclusions about the formation to take an action concerning the formation.

2. The method of claim 1 wherein the second array of receiver locations is different from the first array of receiver locations.

3. The method of claim 1 wherein:
a portion of the first borehole has substantially the shape of a spiral around the plurality of points on the reflecting feature in the formation; and
a portion of the second borehole has substantially the shape of a spiral around the plurality of points on the reflecting feature in the formation.

4. The method of claim 1 wherein:
the first array of source locations and the first array of receiver locations forming a symmetric pattern with respect to the plurality of points on the reflecting feature; and
the second array of source locations and the second array of receiver locations forming a symmetric pattern with respect to the plurality of points on the reflecting feature.

5. The method of claim 1 wherein:
a line substantially collinear with the first array of source locations passes through the reflecting feature at a first point;
a line substantially collinear with the first array of receiver locations passes through the reflecting feature at a second point;
a first direction vector is substantially collinear with the first array of source locations and points in the direction of a surface of the earth;
a second direction vector is collinear with the first array of receiver locations and points in the direction of the surface of the earth;
a vector sum of a projection of the first direction vector onto the reflecting feature and a projection of the second direction vector onto the reflecting feature is along a line connecting the first point to the second point;
a line substantially collinear with the second array of source locations passes through the reflecting feature at a third point;
a line substantially collinear with the second array of receiver locations passes through the reflecting feature at a fourth point;
a third direction vector is substantially collinear with the second array of source locations and points in the direction of a surface of the earth;
a fourth direction vector is collinear with the second array of receiver locations and points in the direction of the surface of the earth;
a vector sum of a projection of the third direction vector onto the reflecting feature and a projection of the fourth direction vector onto the reflecting feature is along a line connecting the third point to the fourth point; and
the line connecting the first point to the second point intersects the line connecting the third point to the fourth point.

6. The method of claim 1 wherein:
the first borehole and the second borehole are the same borehole.

7. The method of claim 1 wherein:
a plurality of first segments of the borehole form symmetric X patterns with a plurality of respective second segments of the borehole.

8. The method of claim 1 wherein:
the first borehole and the second borehole have substantially the shape of a double helix.

9. The method of claim 1 wherein:
the reflecting feature is closer to a surface of the earth than the first array of source locations and the first array of receiver locations.

10. The method of claim 1 wherein one source location of the first array of source locations is at a bit being used to drill the first borehole.

11. The method of claim 1 wherein the action is drilling a borehole.

12. A computer program stored in a non-transitory tangible computer readable storage medium, the program comprising executable instructions that cause a computer to:
collect first seismic data from a plurality of points on a reflecting feature in the formation by emitting a first seismic signal from a first array of source locations in a deviated portion of a first borehole drilled through a formation and receiving first reflections of the first seismic signal from the reflecting feature by a first array of receiver locations in a deviated portion of a second borehole drilled through the formation;
collect second seismic data from the plurality of points on the reflecting feature in the formation by emitting a second seismic signal from a second array of source locations in the deviated portion of the first borehole, the second array of source locations being different from the first array of source locations, and receiving second reflections of the second seismic signal from the plurality of points on the reflecting feature by a second array of receiver locations in the deviated portion of the second borehole;
analyze the collected first seismic data and the collected second seismic data to draw conclusions about the formation;
use the conclusions about the formation to take an action concerning the formation.

13. The computer program of claim 12 wherein the second array of receiver locations is different from the first array of receiver locations.

14. The computer program of claim 12 wherein:
the first array of source locations and the first array of receiver locations forming a symmetric pattern with respect to the plurality of points on the reflecting feature; and
the second array of source locations and the second array of receiver locations forming a symmetric pattern with respect to the plurality of points on the reflecting feature.

15. The computer program of claim 12 wherein:
the first borehole and the second borehole are the same borehole.

16. The computer program of claim 12 wherein:
the reflecting feature is closer to a surface of the earth than the first array of source locations and the first array of receiver locations.

17. The computer program of claim 12 wherein one source location of the first array of source locations is at a bit being used to drill the first borehole.

18. A method comprising:
a computer receiving seismic data from a plurality of points on a reflecting feature in a formation by an array of receiver locations in a deviated portion of at least one borehole drilled within the formation;
the computer analyzing the collected seismic data to draw conclusions about the formation;
the computer using the conclusions about the formation to take an action concerning the formation.

19. The method of claim 18 wherein:
the deviated portion of the borehole is substantially a spiral.

20. The method of claim 18 wherein:
the reflecting feature is closer to a surface of the earth than the array of receiver locations.
